(19) United States
(12) Patent Application Publication
(10) Pub. No.: US 2024/0118840 A1
(43) Pub. Date: Apr. 11, 2024

(54) SYSTEM, CONTROL METHOD, CLIENT TERMINAL, PRINTING APPARATUS, AND STORAGE MEDIUM

(71) Applicant: CANON KABUSHIKI KAISHA, Tokyo (JP)

(72) Inventor: YUTO TERASHIMA, Miyagi (JP)

(21) Appl. No.: 18/481,842

(22) Filed: Oct. 5, 2023

(30) Foreign Application Priority Data
Oct. 6, 2022 (JP) 2022-161363

(51) Int. Cl. G06F 3/12

(52) U.S. Cl. CPC G06F 3/1204; G06F 3/126; G06F 3/1287

(57) ABSTRACT

Some embodiments provide a mechanism for providing print services applicable to a printer to be used by a user at the time of printing in a metaverse. According to an aspect of the present disclosure, a system includes a printing apparatus, a client terminal, and a server for providing a user with a metaverse via the client terminal. The system includes a plurality of memories and a plurality of processors that are configured to receive, from the user, an operation for using a print service for a content in the metaverse; upon reception of an operation for using the print service, acquire information about the printing apparatus from the printing apparatus; and provide a print service applicable to the printing apparatus in the metaverse based on the information about the printing apparatus.

### BACKGROUND

### Field of the Disclosure

The present disclosure relates to a system for printing electronic data provided in a metaverse, a method for controlling the system, a client terminal, a printing apparatus, and a storage medium.

### Description of the Related Art

In conventional cases of printing, print settings, such as the print paper size and print color, may be preset on a client terminal. Japanese Patent Application Laid-Open No. 2012-123778 discusses a technique for providing two different print setting screens. One setting screen supports print settings dedicated to a printing target printer at the issuance of a print instruction, and the other setting screen is a general-purpose setting screen for supporting print settings common to a plurality of printers for a case where no printing target printer is determined at the issuance of a print instruction.

Recent years have seen an increase in the use of a metaverse for providing various services in a three-dimensional virtual space configured on the Internet. A user can access the metaverse by using a dedicated hardware component supporting the drawing of virtual objects, such as a head mounted display and a smart glass, and a terminal incorporating a program execution environment, such as a personal computer (PC) or a smart phone. Further, the user can use various services provided in the metaverse by operating an avatar as a character representing the user himself or herself in the metaverse. An office, a conventional printing environment, has been provided in a service as a virtual office in the metaverse.

With the increase in the use of such a metaverse, there are potential demands for printing documents, images, and other contents in the metaverse.

It is assumed that users operating their own avatars who have gotten into the virtual office are working in different real environments. For example, a certain user works at home as a real environment where a printer for home use is installed, and another user works in a company as a real environment where a printer for business use is installed. It is demanded that print services, such as a setting screen that best suits a printer installed in the real environment where the user works, are provided at the time of printing in a metaverse.

### SUMMARY

Some embodiments of the present disclosure are directed to providing a mechanism for providing print services suitable for a printer used by a user at the time of printing in a metaverse.

According to an aspect of the present disclosure, a system includes a printing apparatus, a client terminal, and a server for providing a user with a metaverse via the client terminal. The system includes a plurality of memories and a plurality of processors that are configured to receive, from the user, an operation for using a print service for a content in the metaverse; upon reception of an operation for using the print service, acquire information about the printing apparatus from the printing apparatus; and provide a print service applicable to the printing apparatus in the metaverse based on the information about the printing apparatus.

Further features of various embodiments will become apparent from the following description of exemplary embodiments with reference to the attached drawings.

### BRIEF DESCRIPTION OF THE DRAWINGS

FIG. 1 illustrates a configuration of a print management system in a metaverse.

FIG. 2 illustrates a hardware configuration of a client terminal.

FIG. 3 illustrates a software configuration of the client terminal.

FIG. 4 illustrates a hardware configuration of an image forming apparatus.

FIG. 5 illustrates a software configuration of the image forming apparatus.

FIG. 6 illustrates a hardware configuration of a server.

FIG. 7 illustrates a software configuration of a metaverse operation server.

FIG. 8 illustrates a software configuration of a printer management server.

FIG. 9 is a sequence diagram illustrating processing for displaying an initial screen in the client terminal.

FIG. 10 is a sequence diagram illustrating processing for registering an image forming apparatus.

FIG. 11 is a flowchart illustrating processing for acquiring apparatus information when an image forming apparatus is registered.

FIG. 12 is a sequence diagram illustrating print processing.

FIG. 13 is a flowchart illustrating processing for acquiring the apparatus information at the time of printing.

FIG. 14 is a sequence diagram illustrating print processing when no image forming apparatus is registered.

FIG. 15 illustrates a login User Interface (UI).

FIG. 16 illustrates an apparatus information input UI.

FIG. 17 illustrates a printing execution UI.

FIG. 18 illustrates a print cancelation UI.

FIG. 19 illustrates an image forming apparatus registration check UI.

FIG. 20 illustrates user information stored in the metaverse operation server.

FIG. 21 illustrates the apparatus information acquired from the image forming apparatus.

FIG. 22 illustrates a print setting UI.

### DESCRIPTION OF THE EMBODIMENTS

Some embodiments of the present disclosure will be described below with reference to the accompanying drawings. The following exemplary embodiments do not limit every embodiment within the scope of the appended claims. Not all of the combinations of the features described in the exemplary embodiments are indispensable to the solutions in every embodiment.

### <Printing System Configuration in Metaverse>

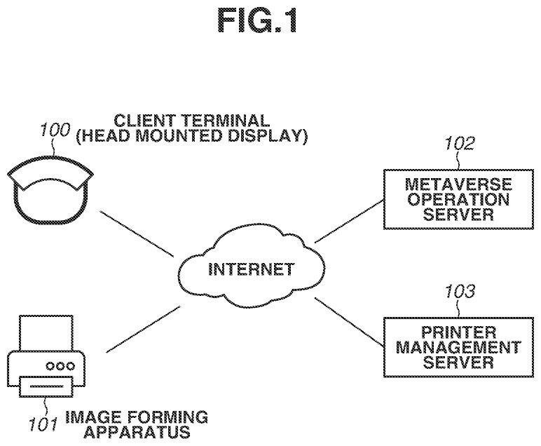

FIG. 1 illustrates an example of a configuration of a print management system in a metaverse. As illustrated in FIG. 1, the print management system according to a first exemplary embodiment includes a client terminal 100, an image forming apparatus 101, a metaverse operation server 102, and a printer management server 103. For example, the client terminal 100 is a network-connectable hardware component supporting the drawing of a metaverse space or other virtual objects, such as a head mounted display. The image forming apparatus 101 is an example of the printing apparatus according to the present disclosure.

The client terminal 100, the image forming apparatus 101, the metaverse operation server 102, and the printer management server 103 are connected to the Internet and are able to exchange information via the Internet. Communication is controlled through HyperText Transfer Protocol (HTTP) or Extensible Messaging and Presence Protocol (XMPP), and other protocols are also applicable.

The metaverse operation server 102 provides the user with a metaverse via the client terminal 100. A metaverse refers to a three-dimensional virtual space configured on a network, such as the Internet, where users operate their own avatars. Users in the metaverse can perform communication and economic activities with other users via their own avatars in real time. Users in different environments in the real space can exist in the same environment in the metaverse. The metaverse operation server 102 provides applications allowing users to use various services in such a virtual space.

### <Hardware Configuration of Client Terminal>

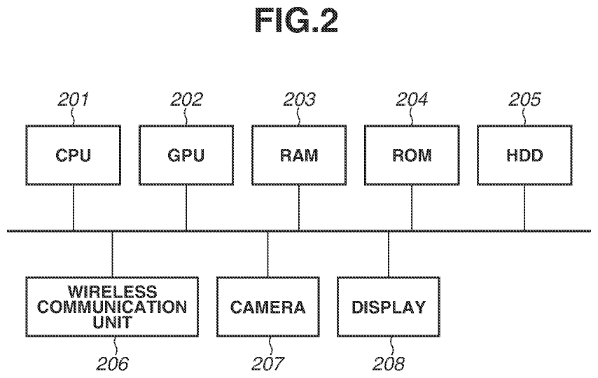

FIG. 2 illustrates an example of a hardware configuration of the client terminal 100. The client terminal 100 includes a central processing unit (CPU) 201, a graphics processing unit (GPU) 202, a random access memory (RAM) 203, a read only memory (ROM) 204, a hard disk drive (HDD) 205, a wireless communications unit 206, a camera 207, and a display 208.

The CPU 201 controls the entire apparatus. The CPU 201 executes application programs and an operating system (OS) stored in the HDD 205 and performs control to temporarily store information and files for program execution in the RAM 203.

The GPU 202 executes calculation processing required to draw virtual objects, such as a metaverse space in real time.

The RAM 203 is a temporary storage unit and functions as the main memory of the CPU 201 and the GPU 202 and a work area.

The ROM 204 is a storage unit for storing basic input and output (I/O) programs and various data.

The HDD 205 is an external storage unit that functions as a mass storage for storing application programs such as a web browser, programs of service servers, the OS, and related programs.

The wireless communication unit 206 is connected with a network, such as the Internet, and performs various communication.

The camera 207 captures images of peripheries of the client terminal 100.

The display 208 as a display unit displays virtual objects, such as the metaverse space, and information necessary for operations.

### <Software Configuration of Client Terminal>

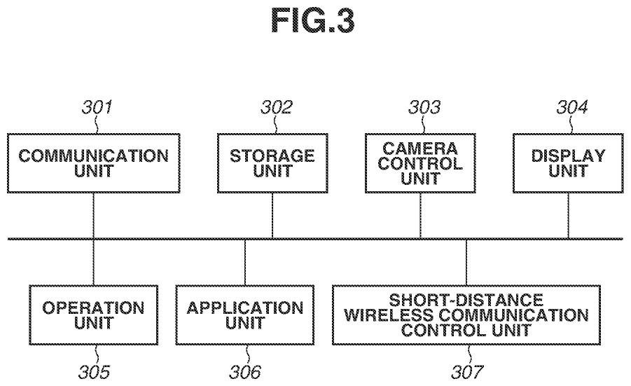

FIG. 3 illustrates an example of a software configuration of the client terminal 100. The software is prestored as programs in the ROM 204 illustrated in FIG. 2. At the time of execution, the CPU 201 loads a program into the RAM 203 and then execute the program.

A communication unit 301 transmits and receives data to/from an external server via a network.

A storage unit 302 performs control to store the OS and web browser to be activated on the client terminal 100, and data of installed applications in the ROM 204.

A camera control unit 303 receives image data acquired from the camera 207.

The display unit 304 displays results of the OS, web browser, and applications on the display 208. For example, the display unit 304 controls the display of virtual objects such as the metaverse space.

The operation unit 305 receives operations on the client terminal 100 itself, gestures performed by the user via the display unit 304, and operations on the accessory controller. The operation unit 305 receives operations, such as physically double-tapping the client terminal 100 itself, to display the web browser and close an application. The operation unit 305 also projects a menu of the OS on the real world image acquired by the camera control unit 303 through the Augmented Reality (AR) technology, and receives an operation, such as tapping, to open the projected menu with the user's hand.

An application unit 306 controls applications installed on the OS of the client terminal 100. The application unit 306 also stores user information to be handled by applications and code information for identifying data in the ROM 204 in cooperation with the storage unit 302.

A short-distance wireless communication control unit 307 controls the wireless communication unit 206 to control the acquisition of peripheral apparatus information via local communication, and the data transmission and reception with peripheral apparatuses. When performing short-distance wireless communication from an application, the short-distance wireless communication control unit 307 performs the data transmission and reception with peripheral apparatuses in cooperation with the application unit 306.

### <Hardware Configuration of Image Forming Apparatus>

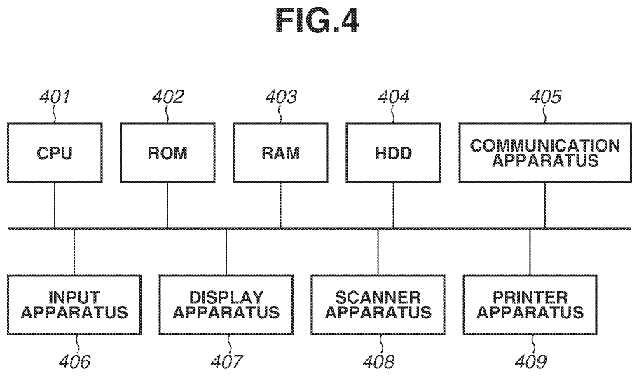

FIG. 4 illustrates an example of a hardware configuration of the image forming apparatus 101. The image forming apparatus 101 includes a CPU 401, a ROM 402, a RAM 403, an HDD 404, a communication apparatus 405, an input apparatus 406, a display apparatus 407, a scanner apparatus 408, and a printer apparatus 409.

The CPU 401 totally controls all of the hardware components to perform functions such as printing and scanning.

The ROM 402 as a memory dedicated for reading data stores, for example, the basic control program of the image forming apparatus 101.

The RAM 403, a data readable/writable memory, is used as a working memory of the CPU 401.

The HDD 404 is used as an area for storing temporary and permanent data used during execution of each program.

The communication apparatus 405 enables the image forming apparatus 101 to connect with a Local Area Network (LAN) and the Internet and perform data communication between apparatuses.

The input apparatus 406 is an operation unit for receiving text and data input operations by the user. Examples of the input apparatus 406 include a keyboard, a mouse, hardware keys, and a touch panel.

The display apparatus 407, such as a liquid crystal display and a touch panel, displays various screens. The user issues an instruction on the user interface screen displayed on the display apparatus 407 via the input apparatus 406, for example, and issues a job execution instruction to the image forming apparatus 101.

The scanner apparatus 408 scans the document placed on the image forming apparatus 101 by the user and generates electronic data.

The printer apparatus 409 is an apparatus for printing electronic data.

### <Software Configuration of Image Forming Apparatus>

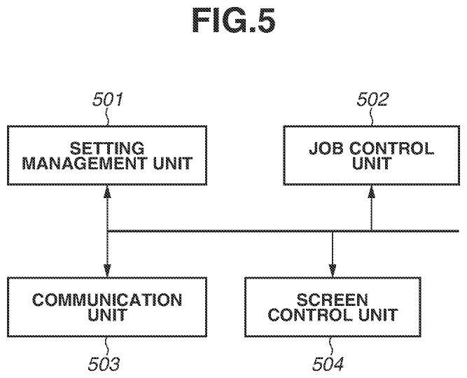

FIG. 5 illustrates an example of a software configuration of the image forming apparatus 101. The software is prestored as programs in the ROM 402 illustrated in FIG. 4. At the time of execution, the CPU 401 loads a program into the RAM 403 and then executes the program.

A setting management unit 501 stores settings about the execution of various functions of the image forming apparatus 101 in the storage devices, such as the RAM 403 and the HDD 404, and reads the settings from each storage device. Examples of the settings include copy settings for performing the copy function, print settings for performing the print function, network settings, and individual identification information.

A job control unit 502 controls the scanner apparatus 408 and the printer apparatus 409 to perform various jobs based on a job execution request input from the input apparatus 406 or received by the communication apparatus 405.

A communication unit 503 receives a print job and a job execution request from the printer management server 103. The communication unit 503 also communicates with the client terminal 100 to transmit and receive apparatus information.

A screen control unit 504 displays a screen on the display apparatus 407 and receives an instruction from the user via the input apparatus 406.

### <Hardware Configuration of Servers>

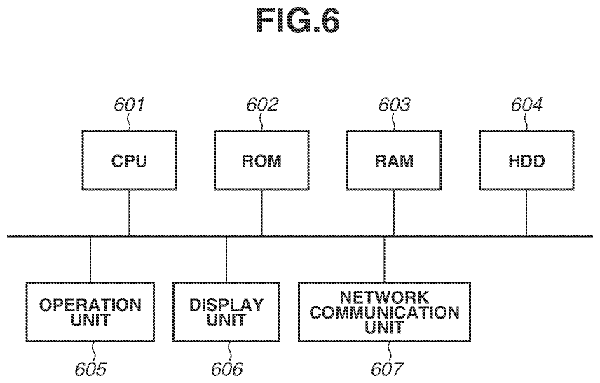

FIG. 6 illustrates an example of a hardware configuration of the metaverse operation server 102. The metaverse operation server 102 includes a CPU 601, a ROM 602, a RAM 603, an HDD 604, an operation unit 605, a display unit 606, and a network communication unit 607.

The CPU 601 is a central processing unit for controlling each unit of the metaverse operation server 102.

The ROM 602 is a read only memory for storing the boot program required for the system activation.

The RAM 603 serves as a work memory required for the CPU 601 to execute a program.

The HDD 604 is an apparatus for storing programs to be executed by the CPU 601 and various information.

The operation unit 605 includes a keyboard and mouse used by the user to perform various input operations.

The display unit 606, a liquid crystal display, is an apparatus for displaying various information.

The network communication unit 607 connects with a network, such as the Internet, to perform various communications.

The printer management server 103 has a hardware configuration similar to that of the metaverse operation server 102, and redundant descriptions thereof will be omitted. However, the printer management server 103 may have a hardware configuration different from that of the metaverse operation server 102.

### <Software Configuration of Metaverse Operation Server>

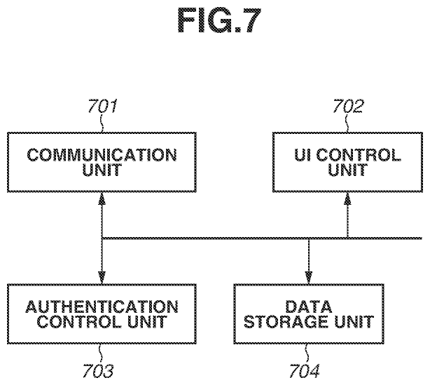

FIG. 7 illustrates an example of a software configuration of the metaverse operation server 102. The software is prestored as programs in the ROM 602 illustrated in FIG. 6. At the time of execution, the CPU 601 loads a program into the RAM 603 and then executes the program.

A communication unit 701 communicates with the client terminal 100 and the printer management server 103 to transmit and receive different processing requests.

A User Interface (UI) control unit 702 controls a UI to be displayed on the client terminal 100. For example, the UI control unit 702 generates virtual object information, such as the metaverse space, and transmits the information to the client terminal 100 via the communication unit 701.

A authentication control unit 703 performs the user management. The authentication control unit 703 stores the user information in a data storage unit 704 or a database (DB) dedicated for the user management (not illustrated). Also, the authentication control unit 703 may cooperate with an external authentication service.

The data storage unit 704 stores data in response to requests from the authentication control unit 703, and also stores information required to generate a virtual object, such as a metaverse space.

### <Software Configuration of Printer Management Server>

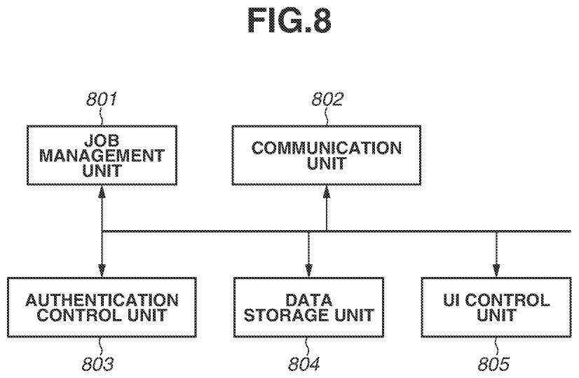

FIG. 8 illustrates an example of a software configuration of the printer management server 103. The software is prestored as programs in the ROM 602 illustrated in FIG. 6. At the time of execution, the CPU 601 loads a program into the RAM 603 and then executes the program.

A job management unit 801 stores the print job received from the metaverse operation server 102 in a data storage unit 804.

A communication unit 802 communicates with the image forming apparatus 101 and the metaverse operation server 102 to transmit and receive different processing requests.

A authentication control unit 803 performs the user management. The authentication control unit 803 stores the user information in the data storage unit 804 or a database (DB) dedicated for the user management (not illustrated). Also, the authentication control unit 803 may cooperate with an external authentication service.

The data storage unit 804 stores data in response to requests from the job management unit 801 or the authentication control unit 803.

A UI control unit 805 controls a print setting UI.

### <Processing for Initial Screen Display on Client Terminal>

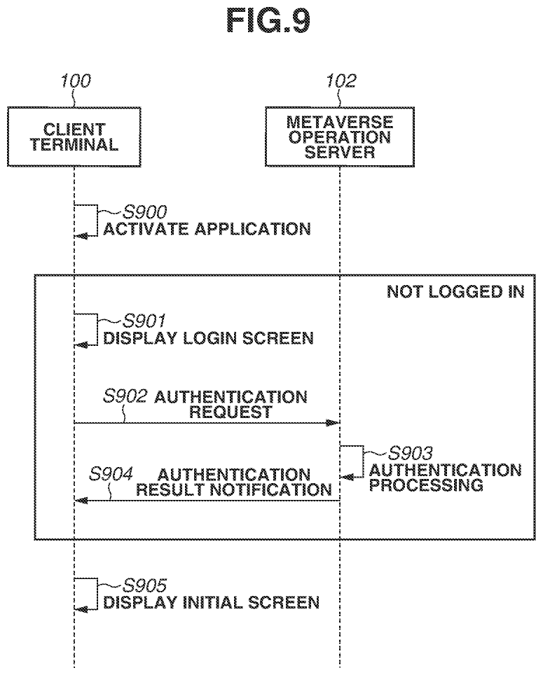

FIG. 9 is a sequence diagram illustrating processing in which the user displays the initial screen on the client terminal 100.

In step S900, when the application unit 306 of the client terminal 100 detects an application activation operation on the operation unit 305, the application unit 306 activates a metaverse application program from the storage unit 302.

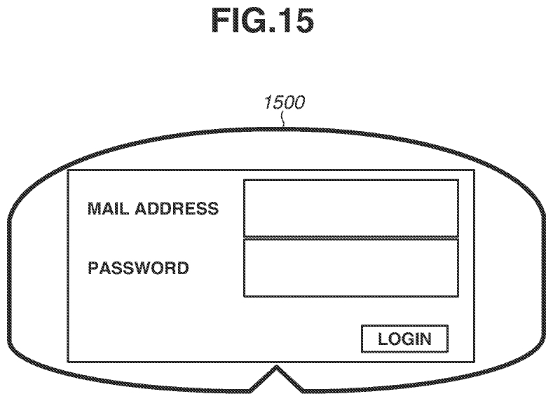

In step S901, the application unit 306 of the client terminal 100 refers to the storage unit 302 to check the login state. When the application unit 306 determines that the login state for an application is a non-login state based on login information stored in the storage unit 302, the application unit 306 displays a login screen on the display unit 304. FIG. 15 illustrates an example of the login screen displayed on the display unit 304 of the client terminal 100. A screen 1500 includes, for example, a Mail Address input field, a Password input field, and a Login button.

In step S902, the application unit 306 of the client terminal 100 transmits an authentication request to the metaverse operation server 102. More specifically, the operation unit 305 detects that the Login button is pressed by the user and notifies the application unit 306 of the event. Upon reception of the information about the depression of the Login button, the application unit 306 transmits the input values of the Mail Address and Password input fields to the metaverse operation server 102 via the communication unit 301.

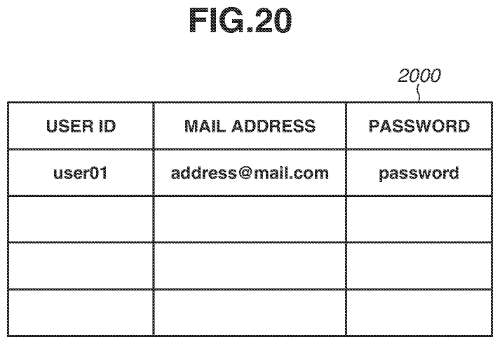

In step S903, the authentication control unit 703 of the metaverse operation server 102 performs authentication processing by using the mail address and password received from the client terminal 100. FIG. 20 illustrates an example of a user management table stored in the data storage unit 704 of the metaverse operation server 102. A user management table 2000 stores, for example, the user ID, mail address, and password. The metaverse operation server 102 receives the account registration by using the mail address and password pre-input by the user, and registers and stores the account, together with the automatically issued user ID to the user management table 2000. The password may be an input plain text or a value generated by a unidirectional function or decodable function. The authentication control unit 703 compares the information in the user management table 2000 with the mail address and password received from the client terminal 100 to determine whether these pieces of information are matched, and stores the result of the comparison as an authentication result.

In step S904, the metaverse operation server 102 returns the obtained authentication result in step S903 to the client terminal 100 via the communication unit 701.

In step S905, when the above-described pieces of information are matched as a result of the authentication in step S903, the application unit 306 of the client terminal 100 displays the initial screen after logging into an application on the display unit 304.

The above-described processing enables the user to display the initial screen of the application on the client terminal 100.

### <Processing for Printer Registration>

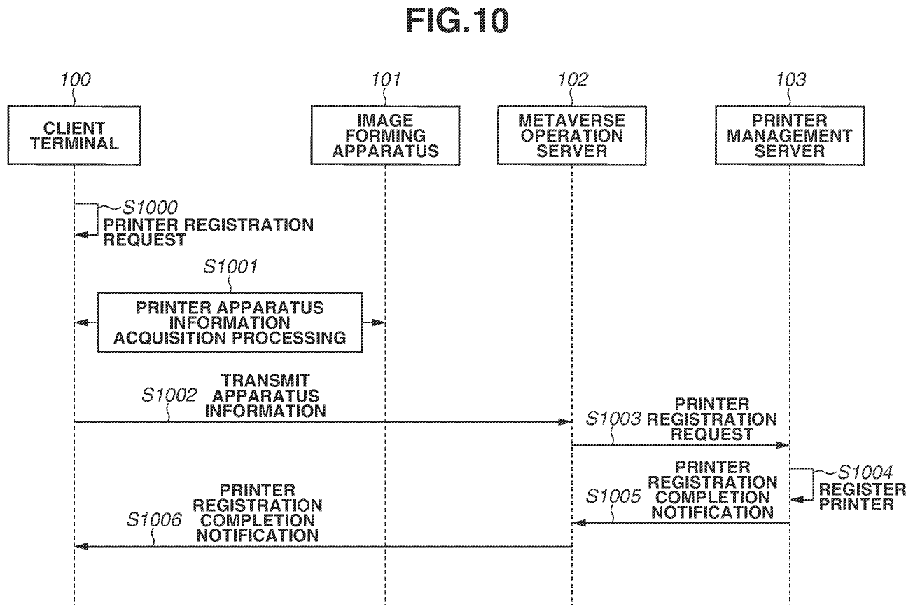

FIG. 10 is a sequence diagram illustrating processing for registering the image forming apparatus 101 to the printer management server 103.

In step S1000, the application unit 306 receives a printer registration operation from the operation unit 305. The printer registration operation is performed in a state where the user is logging into an application.

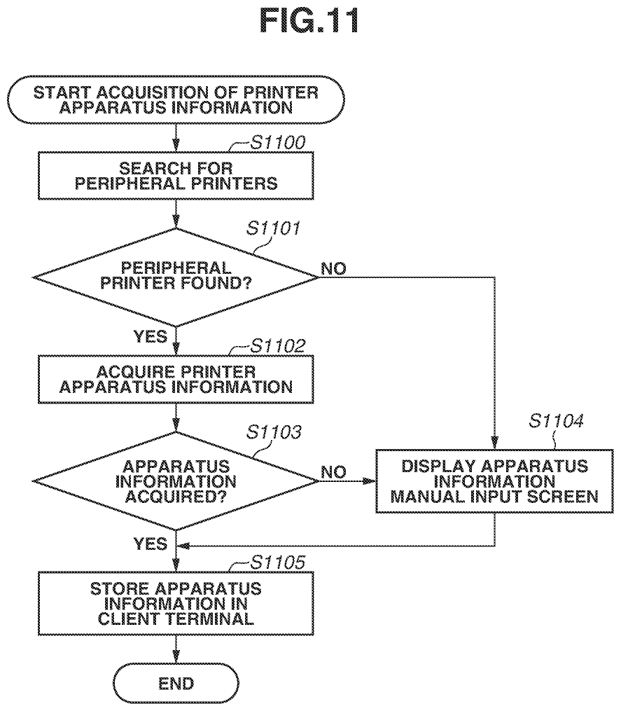

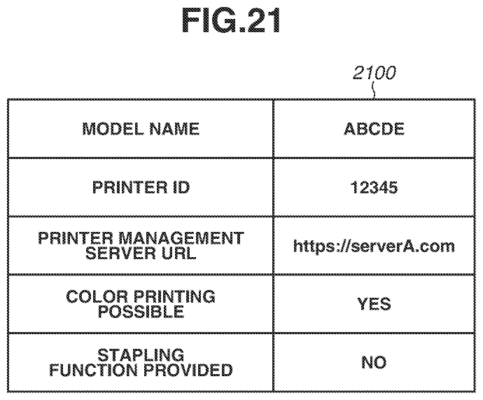

In step S1001, the client terminal 100 acquires the apparatus information for the printer from the image forming apparatus 101 via the short-distance wireless communication control unit 307. Processing for the apparatus information acquisition is illustrated in FIG. 11. The processing will be described in detail below. FIG. 21 illustrates an example of the apparatus information 2100 acquired in step S1001. The apparatus information includes, for example, a model name, the printer ID for uniquely identifying the printer, and the Uniform Resource Locator (URL) of the printer management server. The URL of the printer management server is assumed to be the URL specified by the sales agency of the printer. The apparatus information also includes functions related to the print function of the printer, such as color printing and a stapling function.

In step S1002, the client terminal 100 transmits the model information received in step S1001 to the metaverse operation server 102 via the communication unit 301.

In step S1003, the metaverse operation server 102 transmits a printer registration request to the printer management server 103 via the communication unit 701. More specifically, the metaverse operation server 102 transmits a printer registration request, together with the apparatus information received in step S1002 and the user ID of the user logging into an application indicated by the user management table 2000. The transmission destination can be identified by the URL of the printer management server 103 included in the apparatus information.

In step S1004, the printer management server 103 stores the apparatus information and the user ID received in step S1003, in the data storage unit 704 in an associated way.

In step S1005, the printer management server 103 transmits a printer registration completion notification to the metaverse operation server 102 via the communication unit 802.

In step S1006, the metaverse operation server 102 transmits a printer registration completion notification to the client terminal 100 via the communication unit 701.

The above-described processing enables the user to register the image forming apparatus 101 to the printer management server 103. According to the present exemplary embodiment, the URL of the printer management server 103 is acquired from the printer. However, the metaverse operation server 102 may hold a predetermined URL of the printer management server 103, and the printer management server 103 may perform the printer management.

### <Processing for Apparatus Information Acquisition at Printer Registration>

FIG. 11 is a flowchart illustrating processing in which the client terminal 100 acquires the apparatus information of the image forming apparatus 101 at the time of printer registration.

In step S1100, when the operation unit 305 receives a printer registration operation by the user, the short-distance wireless communication control unit 307 of the client terminal 100 searches for peripheral printers.

In step S1101, the application unit 306 of the client terminal 100 determines whether a printer has been found in the vicinity of the client terminal 100 as a result of the processing in step S1100. When a printer has been found (YES in step S1101), the processing proceeds to step S1102.

On the other hand, when no printer was found (NO in step S1101), the processing proceeds to step S1104.

In step S1102, the short-distance wireless communication control unit 307 performs the apparatus information acquisition processing for the printer found in step S1100. The apparatus information refers to the information illustrated in FIG. 21. When a plurality of printers has been found, the client terminal 100 displays a list of the printers on the display unit 304, receives a printer selection operation by the user via the operation unit 305, and performs the apparatus information acquisition processing for the selected printer.

In step S1103, the application unit 306 of the client terminal 100 determines whether the apparatus information has been acquired as a result of the processing in step S1102. When the apparatus information has been acquired (YES in step S1103), the processing proceeds to step S1105. On the other hand, when the apparatus information has not been acquired (NO in step S1103), the processing proceeds to step S1104.

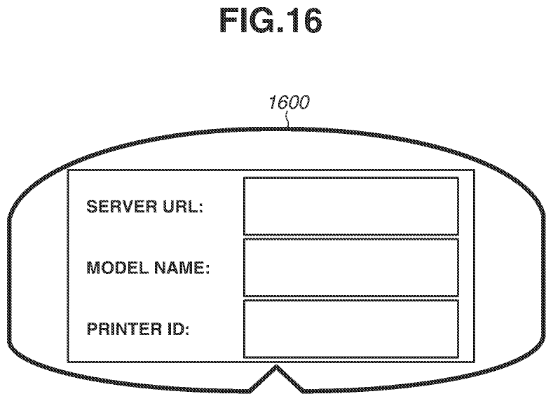

In step S1104, the display unit 304 of the client terminal 100 displays a manual input screen for the apparatus information illustrated in FIG. 16. A manual input screen 1600 for the apparatus information receives, for example, the URL of the printer management server 103, the model name of the printer, and the ID for uniquely identifying the printer.

In step S1105, the application unit 306 of the client terminal 100 records the apparatus information in the storage unit 302 thereof and then completes the processing.

The above-described processing enables the client terminal 100 to acquire the apparatus information of the image forming apparatus 101.

### <Processing for Printing Execution>

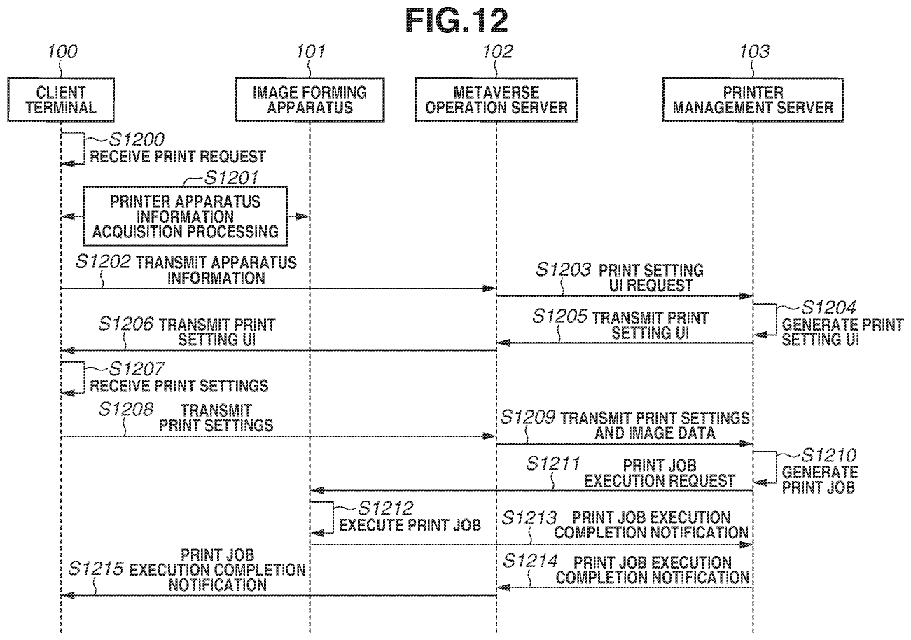

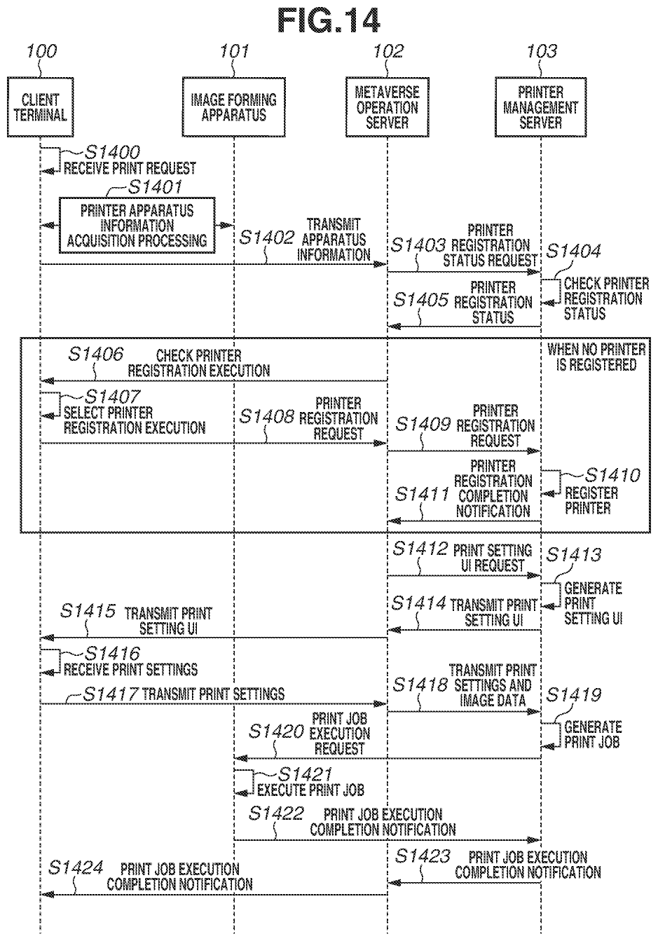

FIG. 12 is a sequence diagram illustrating processing in which a print setting UI suitable for the image forming apparatus 101 to be used by the user is displayed, and then prints a content in the metaverse space on the image forming apparatus 101. This processing is performed on the premise that the printer registration illustrated in FIG. 10 has been completed. Processing for printing execution in a case where the printer registration has not been completed will be described below with reference to FIG. 14.

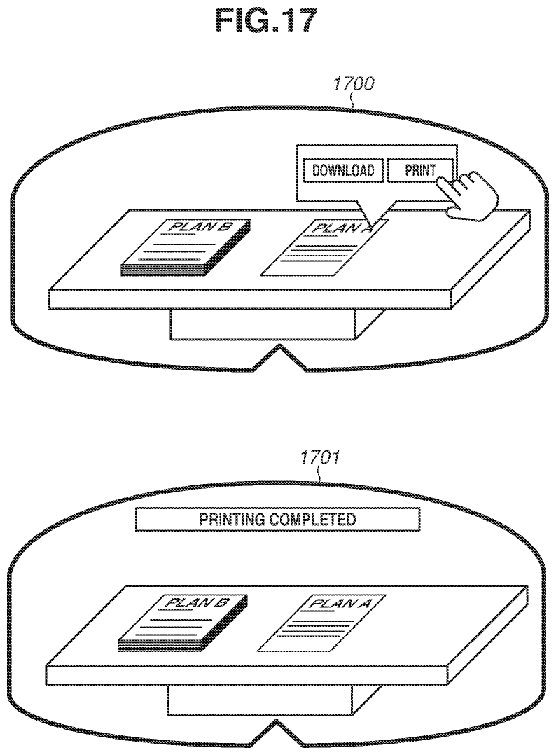

In step S1200, the operation unit 305 of the client terminal 100 receives a print request from the user. FIG. 17 illustrates an example of a screen 1700 as a UI for receiving a print request. The user selects a content to be printed and performs a printing execution operation in the metaverse.

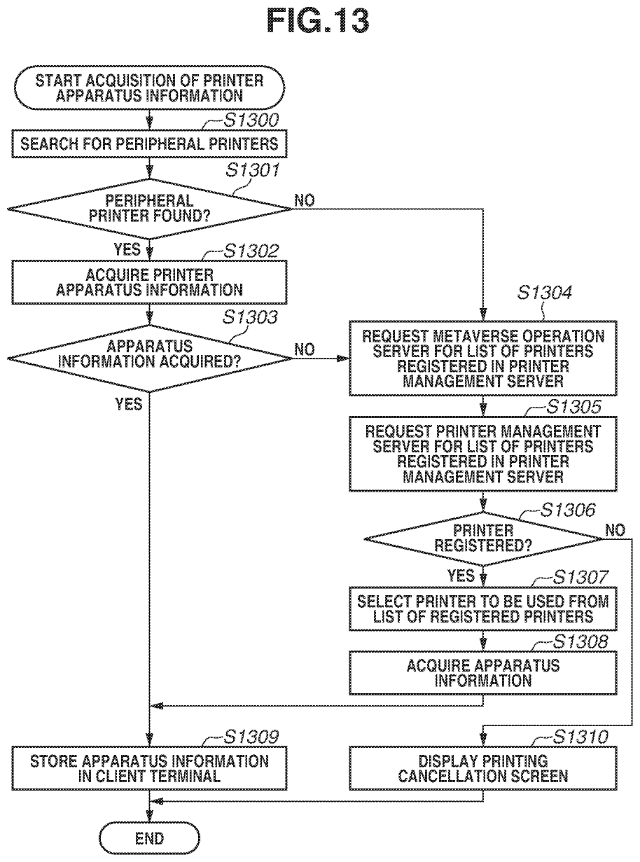

In step S1201, the client terminal 100 acquires the apparatus information of the printer from the image forming apparatus 101 via the short-distance wireless communication control unit 307. Processing for the apparatus information acquisition will be described below with reference to FIG. 13. The processing will be described in detail below. The apparatus information refers to the information illustrated in FIG. 21.

In step S1202, the client terminal 100 transmits the model information received in step S1201 to the metaverse operation server 102 via the communication unit 301.

In step S1203, the metaverse operation server 102 transmits a print setting UI request to the printer management server 103 via the communication unit 701. More specifically, the metaverse operation server 102 transmits a print setting UI request, together with the apparatus information received in step S1202 and the user ID of the user logging into an application indicated by the user management table 2000. The transmission destination can be identified by the URL of the printer management server 103 included in the apparatus information.

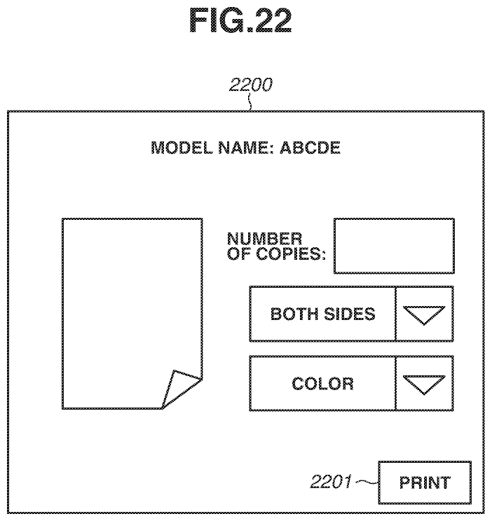

In step S1204, the printer management server 103 checks whether the apparatus information and the user ID received in step S1203 are stored in the data storage unit 804. Then, the UI control unit 805 generates a print setting UI based on the printer information received in step S1203. For example, when the apparatus information illustrated in FIG. 21 is received, the print setting UI illustrated in FIG. 22 is generated. This UI enables setting the color print function in addition to the basic functions of the model name ABCDE but does not enable setting the stapling function. In this way, a print setting UI suitable for the printer to be used by the user can be generated.

In step S1205, the printer management server 103 transmits the print setting UI generated in step S1204 to the metaverse operation server 102 via the communication unit 802.

In step S1206, the UI control unit 702 of the metaverse operation server 102 transmits the print setting UI received in step S1205 to the client terminal 100. Then, the display unit 304 of the client terminal 100 displays a received print setting UI 2200 on the display 208.

In step S1207, the operation unit 305 of the client terminal 100 receives print settings from the user on the print setting UI 2200. Then, when the operation unit 305 detects that a Print button 2201 for issuing a print instruction is pressed on the print setting UI 2200, the processing proceeds to step S1208.

In step S1208, the client terminal 100 transmits the print settings received in step S1207 to the metaverse operation server 102 via the communication unit 301.

In step S1209, the metaverse operation server 102 transmits the print settings received in step S1208 and the printing target data of the content operated on the screen 1700, to the printer management server 103 via the communication unit 701.

In step S1210, the job management unit 801 of the printer management server 103 generates a print job based on the print settings and image data received in step S1209.

In step S1211, the printer management server 103 transmits a request for executing the print job generated in step S1210 to the image forming apparatus 101 via the communication unit 802.

In step S1212, the job control unit 502 of the image forming apparatus 101 executes the print job received in step S1211.

In step S1213, the image forming apparatus 101 transmits the result of the print job execution to the printer management server 103 via the communication unit 503.

In step S1214, the printer management server 103 transmits the result of the print job execution to the metaverse operation server 102 via the communication unit 802.

In step S1215, the metaverse operation server 102 transmits the result of the print job execution to the client terminal 100 via the communication unit 701. The result of the print job execution is notified to the user, for example, in a form 1701 illustrated in FIG. 17.

The above-described processing enables displaying a print setting UI suitable for the image forming apparatus 101 to be used by the user, and printing a content in the metaverse space on the image forming apparatus 101. Although, according to the present exemplary embodiment, the printer management server 103 generates a print setting UI, a separate server may be used to generate a print setting UI.

### <Processing for Apparatus Information Acquisition at Printing Execution>

FIG. 13 is a flowchart illustrating processing in which the client terminal 100 acquires the apparatus information of the image forming apparatus 101 at the time of printing execution.

In step S1300, the short-distance wireless communication control unit 307 of the client terminal 100 searches for peripheral printers.

In step S1301, the application unit 306 of the client terminal 100 determines whether a printer has been found in the vicinity of the client terminal 100 as a result of the processing in step S1300. When a printer has been found (YES in step S1301), the processing proceeds to step S1302.

On the other hand, when no printer has been found (NO in step S1301), the processing proceeds to step S1304.

In step S1302, the short-distance wireless communication control unit 307 performs the apparatus information acquisition processing for the printer found in step S1300. The apparatus information refers to the information illustrated in FIG. 21. When a plurality of printers has been found, the client terminal 100 displays a list of the printers on the display unit 304, receives a printer selection operation by the user via the operation unit 305, and performs the apparatus information acquisition processing for the selected printer.

In step S1303, the application unit 306 of the client terminal 100 determines whether the apparatus information has been acquired as a result of the processing in step S1302. When the apparatus information has been acquired (YES in step S1303), the processing proceeds to step S1309. On the other hand, when the apparatus information has not been acquired (NO in step S1303), the processing proceeds to step S1304.

In step S1304, the client terminal 100 requests the metaverse operation server 102 for a list of printers registered in the printer management server 103, via the communication unit 301.

In step S1305, the metaverse operation server 102 requests the printer management server 103 for a list of printers registered in the printer management server 103, via the communication unit 701.

In step S1306, when one or more printers are registered in the printer management server 103, the printer management server 103 transmits a list of the printers and the apparatus information of each printer to the metaverse operation server 102 via the communication unit 802. Then, the processing proceeds to step S1307. When no printer is registered, the printer management server 103 transmits a notification that no printer is registered to the metaverse operation server 102, via the communication unit 802. Then, the processing proceeds to step S1310.

In step S1307, the metaverse operation server 102 transmits the printer list received in step S1306 to the client terminal 100, via the communication unit 701. Then, the display unit 304 of the client terminal 100 displays the printer list and the operation unit 305 receives a printer selection operation by the user.

In step S1308, the application unit 306 of the client terminal 100 acquires the apparatus information of the printer selected in step S1307.

In step S1309, the application unit 306 of the client terminal 100 records the acquired apparatus information of the printer in the storage unit 302 thereof and then completes the processing.

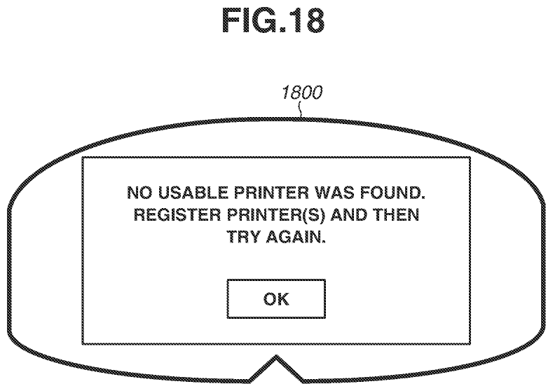

In step S1310, the display unit 304 of the client terminal 100 displays the print cancel screen 1800 illustrated in FIG. 18 and completes the processing.

The above-described processing enables the client terminal 100 to acquire the apparatus information of the image forming apparatus 101.

<Processing for Printing Execution when No Printer is Registered>

FIG. 12 illustrates processing in which the image forming apparatus 101 prints a content in the metaverse space on the premise that the printer registration illustrated in FIG. 10 is completed. However, there may be a case where the user performs a printing operation without performing the printer registration. FIG. 14 illustrates processing for printing execution in such a case.

Steps S1400 to S1402 are similar to steps S1200 to S1202, respectively, and redundant descriptions thereof will be omitted.

In step S1403, the metaverse operation server 102 transmits a printer registration status request to the printer management server 103, together with the apparatus information received in step S1402 and the user ID indicated by the user management table 2000, via the communication unit 701.

In step S1404, the printer management server 103 checks whether the printer information and the user ID received in step S1403 are stored in the data storage unit 804.

In step S1405, the printer management server 103 transmits the printer registration status confirmed in step S1404 to the metaverse operation server 102, via the communication unit 802.

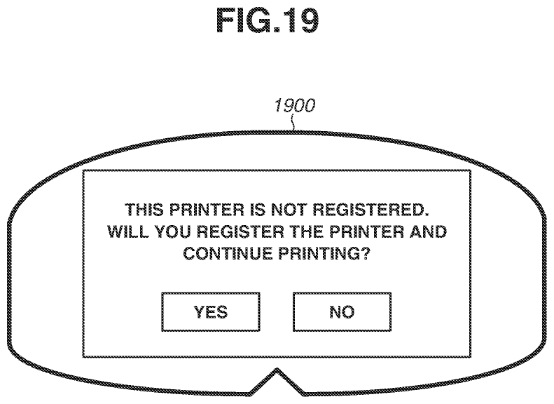

In step S1406, when no printer is registered, the metaverse operation server 102 transmits a UI 1900 for checking whether to perform the printer registration illustrated in FIG. 19, to the client terminal 100 via the communication unit 701.

In step S1407, the client terminal 100 displays the UI received in step S1406 on the display unit 304 and receives a printer registration operation on the operation unit 305.

In step S1408, the client terminal 100 transmits a printer registration request to the metaverse operation server 102 via the communication unit 301.

In step S1409, the metaverse operation server 102 transmits a printer registration request to the printer management server 103 via the communication unit 701. More specifically, the metaverse operation server 102 transmits a printer registration request, together with the apparatus information received in step S1402 and the user ID of the user logging into an application indicated by the user management table 2000.

Steps S1410 to S1411 are similar to steps S1004 to S1005, respectively, and redundant descriptions thereof will be omitted.

In step S1412, the metaverse operation server 102 transmits a print setting UI request to the printer management server 103 via the communication unit 701. More specifically, the metaverse operation server 102 transmits a printer setting UI request, together with the apparatus information received in step S1402 and the user ID of the user logging into an application indicated by the user management table 2000.

Steps S1413 to S1424 are similar to steps S1204 to S1215, respectively, redundant descriptions thereof will be omitted.

Even if the user performs a printing operation without performing the printer registration, the above-described processing enables the user to register a printer and then perform printing.

The present exemplary embodiment has been described above centering on a form for transmitting the apparatus information from the printing apparatus to display a print setting UI corresponding to the functions of the printing apparatus to be used in the real space by the user in the metaverse. The present disclosure may have a form of providing not only the print setting UI but also a print service applicable to the printing apparatus to be used by the user in the real space, based on the apparatus information transmitted from the printing apparatus. Examples of print services include the display of an avatar for the printing apparatus to be used by the user in the real space, and a notification of the printing status of the printing apparatus.

### Other Exemplary Embodiments

Some embodiments of the present disclosure can also be achieved when a program for implementing at least one of the functions according to the above-described exemplary embodiments is supplied to a system or apparatus via a network or storage medium, and at least one processor in a computer of the system or apparatus reads and executes the computer-executable instructions. Further, some embodiments of the present disclosure can also be achieved by a circuit (for example, an Application Specific Integrated Circuit (ASIC) and Field Programmable Gate Array (FPGA)) for implementing at least one function.

Embodiments of the present disclosure make it possible to provide a mechanism for providing print services applicable to a printer to be used by a user at the time of printing in a metaverse.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-161363, which was filed on Oct. 6, 2022 and which is hereby incorporated by reference herein in its entirety.

What is claimed is:

1. A system comprising a printing apparatus, a client terminal, and a server configured to provide a user with a metaverse via the client terminal, wherein the system comprises:
a plurality of memories; and
a plurality of processors, wherein the plurality of processors and the plurality of memories are configured to:
receive from the user an operation for using a print service for a content in the metaverse;
acquire, upon reception of an operation for using the print service, information about the printing apparatus from the printing apparatus; and
provide, based on the information about the printing apparatus, a print service applicable to the printing apparatus in the metaverse.

2. A method for controlling a system including a printing apparatus, a client terminal, and a server configured to provide a user with a metaverse via the client terminal, the method comprising:
receiving from the user an operation for using a print service for a content in the metaverse;
acquiring, upon reception of an operation for using the print service, information about the printing apparatus from the printing apparatus; and
providing, based on the information about the printing apparatus, a print service applicable to the printing apparatus in the metaverse.

3. A client terminal usable for enabling a user to access a metaverse provided by a server, wherein the client terminal comprises:
one or more memories; and
one or more processors, wherein the one or more processors and the one or more memories are configured to:
acquire, upon reception of an operation for using a print service for a content in the metaverse by the user, information about a printing apparatus from the printing apparatus; and
transmit the acquired information via a network so that a print service applicable to the printing apparatus is provided in the metaverse.

4. The client terminal according to claim 3, wherein the information includes at least either one of identification information of the printing apparatus and information about a print function provided by the printing apparatus.

5. The client terminal according to claim 4, wherein the information about the print function is information about at least either one of a color print function and a stapling function.

6. The client terminal according to claim 3, wherein the client terminal is a network-connectable head mounted display.

7. The client terminal according to claim 3, wherein, upon reception of an operation for using a print service for a content in the metaverse by the user, the one or more processors and the one or more memories are further configured to acquire information about a wirelessly connected printing apparatus from the printing apparatus.

8. The client terminal according to claim 3, wherein the one or more processors and the one or more memories are further configured to transmit the acquired information to the server via the network.

9. The client terminal according to claim 3, wherein the provision of the print service in the metaverse include at least any one of display of a print setting UI applicable to functions of the printing apparatus, display of an avatar for the printing apparatus, and notification of a status of the printing apparatus.

10. The client terminal according to claim 3, wherein print data corresponding to the content is printed by the printing apparatus in response to an additional operation by the user on the print service provided in the metaverse.

11. A method for controlling a client terminal usable for enabling a user to access a metaverse provided by a server, the method comprising:
acquiring, upon reception of an operation for using a print service for a content in the metaverse by the user, information about a printing apparatus from the printing apparatus; and
transmitting the acquired information via a network so that a print service applicable to the printing apparatus is provided in the metaverse.

12. A non-transitory storage medium storing computer-executable instructions for causing a computer to execute a method for controlling a client terminal usable for enabling a user to access a metaverse provided by a server,
the method comprising:
acquiring, upon reception of an operation for using a print service for a content in the metaverse by the user, information about a printing apparatus from the printing apparatus; and
transmitting the acquired information via a network so that a print service applicable to the printing apparatus is provided in the metaverse.

13. A printing apparatus connectable, via a network, with a client terminal usable for enabling a user to access a metaverse provided by a server, wherein the printing apparatus comprises:
one or more memories; and
one or more processors, wherein the one or more processors and the one or more memories are configured to:
transmit information about the printing apparatus to the client terminal so that a print service applicable to the printing apparatus is provided in the metaverse; and
receive a print job corresponding to a content in the metaverse according to an operation by the user on the print service provided in the metaverse.

14. The printing apparatus according to claim 13, wherein the information includes at least either one of identification information of the printing apparatus and information about a print function provided by the printing apparatus.

15. The printing apparatus according to claim 14, wherein the information about the print function is information about at least either one of a color print function and a stapling function.

16. The printing apparatus according to claim 13, wherein the one or more processors and the one or more memories are further configured to transmit the information about the printing apparatus to a wirelessly connected client terminal.

17. The printing apparatus according to claim 13, wherein the provision of the print service in the metaverse include at least any one of display of a print setting UI applicable to functions of the printing apparatus, display of an avatar for the printing apparatus, and notification of a status of the printing apparatus.

18. A method for controlling a printing apparatus connectable, via a network, with a client terminal usable for enabling a user to access a metaverse provided by a server, the method comprising:
transmitting information about the printing apparatus to the client terminal so that a print service applicable to the printing apparatus is provided in the metaverse; and
receiving a print job corresponding to a content in the metaverse according to an operation by the user on the print service provided in the metaverse.

19. A non-transitory storage medium storing computer-executable instructions for executing a method for controlling a printing apparatus connectable, via a network, with a client terminal usable for enabling a user to access a metaverse provided by a server,
the method comprising:
transmitting information about the printing apparatus to the client terminal so that a print service applicable to the printing apparatus is provided in the metaverse; and
receiving a print job corresponding to a content in the metaverse according to an operation by the user on the print service provided in the metaverse.
